(19) United States
(12) Patent Application Publication
(10) Pub. No.: US 2018/0007340 A1
(43) Pub. Date: Jan. 4, 2018

(54) METHOD AND SYSTEM FOR MOTION CONTROLLED MOBILE VIEWING

(71) Applicant: Barbara Carey Stachowski, Orinda, CA (US)

(72) Inventor: Barbara Carey Stachowski, Orinda, CA (US)

(21) Appl. No.: 15/610,081

(22) Filed: May 31, 2017

Related U.S. Application Data
(60) Provisional application No. 62/356,368, filed on Jun. 29, 2016.

(51) Int. Cl. H04N 13/00; H04N 5/232; G06F 17/30; H04N 13/04; G06F 3/0488; G06Q 50/16; G06F 3/0481; G06F 3/01; G06Q 30/02; G06Q 30/06; G06F 3/0483

(52) U.S. Cl. CPC H04N 13/0014; H04N 13/045; H04N 13/0497; H04N 5/23238; G06F 17/30864; G06F 2203/04806; G06F 3/0488; G06F 3/0483; G06F 3/04815; G06F 3/017; G06Q 30/0267; G06Q 30/0643; G06Q 50/16; G06Q 30/0256

(57) ABSTRACT

Search Engine Optimization (SEO) includes utilizing pop up drawers to enable additional content to be considered part of a main page which enables the drawer content to be included in search engine searches. Additionally, a portal which supports many separate real estate listings by separate entities provides further SEO benefits. A zoom implementation enables a user to navigate content such as images easily using a mobile device. Using the zoom implementation, a user is able to view an image that is larger than the screen of the mobile device by moving the device which pans to view different aspects of the image. The zoom implementation is able to take advantage of the accelerometer and/or gyroscope of the mobile device to control the displayed image.

### CROSS-REFERENCE TO RELATED APPLICATION(S)

This application claims priority under 35 U.S.C. §119(e) of the U.S. Provisional Patent Application Ser. No. 62/356,368, filed Jun. 29, 2016 and titled, “METHOD AND SYSTEM FOR MOTION CONTROLLED MOBILE VIEWING,” which is hereby incorporated by reference in its entirety for all purposes.

### FIELD OF THE INVENTION

The present invention is in the technical field of mobile devices. More particularly, the present invention is in the technical field of optimizing viewing on mobile devices.

### BACKGROUND OF THE INVENTION

Search engine crawlers find information first from the first page of a website. Single property/product websites with a landing page that has most of the information on one page have become typical. These pages scroll vertically and many have parallax designs and are viewable on all devices.

### SUMMARY OF THE INVENTION

Search Engine Optimization (SEO) includes utilizing pop up drawers to enable additional content to be considered part of a main page which enables the drawer content to be included in search engine searches. Additionally, a portal which supports many separate real estate listings by separate entities provides further SEO benefits.

A zoom implementation enables a user to navigate content such as images easily using a mobile device. Using the zoom implementation, a user is able to view an image that is larger than the screen of the mobile device by moving the device which pans to view different aspects of the image. The zoom implementation is able to take advantage of the accelerometer and/or gyroscope of the mobile device to control the displayed image.

### BRIEF DESCRIPTION OF THE DRAWINGS

FIG. 1 shows a screenshot of a main page according to some embodiments.

FIG. 2 shows a screenshot of drawers according to some embodiments.

FIG. 3 shows screenshots of an image drawer, a map drawer and a video drawer according to some embodiments.

FIG. 4 shows screenshots of an image with the top and bottom bars and an image without the top and bottom bars according to some embodiments.

FIG. 5 shows three axes for the accelerometer according to some embodiments.

FIG. 6 shows screenshots of real estate images according to some embodiments.

FIG. 7 shows a screenshot of a real estate image with much of the image cropped or out of sight according to some embodiments.

FIG. 8 shows a screenshot of a tool to edit an image according to some embodiments.

FIG. 9 shows a diagram of an exemplary range of verticality according to some embodiments.

FIG. 10 shows a diagram of an indicator marker for the user to see if the user is in a range of verticality according to some embodiments.

FIG. 11 shows a screenshot of a 3D view controllable with the accelerometer and/or gyroscope according to some embodiments.

FIG. 12 illustrates a screenshot of configurable display options according to some embodiments.

FIG. 13 illustrates a screenshot of the zoom implementation with platform tool buttons accessible according to some embodiments.

FIG. 14 illustrates an exemplary representation of panning through a large image on a mobile device according to some embodiments.

FIG. 15 illustrates a diagram of a drone being used in conjunction with the zoom implementation according to some embodiments.

FIG. 16 shows an example of a photo mode view of an image and a pano (panoramic) mode view in a portrait display according to some embodiments.

FIG. 17 shows an example of a photo mode view of an image and a pano (panoramic) mode view in a landscape display according to some embodiments.

FIG. 18 shows an example of a button implementation according to some embodiments.

FIG. 19 shows an example of an implementation for acquiring pictures and videos according to some embodiments.

FIG. 20 shows an example of an implementation for acquiring pictures and videos according to some embodiments.

FIG. 21 shows an example of an implementation of editing acquired pictures or videos according to some embodiments.

FIG. 22 shows an example of an implementation for utilizing the acquired pictures or videos according to some embodiments.

FIG. 23 shows a diagram of a mobile device controlling a display of a second device using the zoom implementation according to some embodiments.

### DETAILED DESCRIPTION OF THE INVENTION

A FlipClip property listing is a naturally page turning book with drawers that have additional content (e.g., images, video, text details, maps). Each main page is viewed on the first level with a DETAILS button. When a viewer selects the DETAILS button, instead of transitioning to a second level, whatever information is in that drawer opens in a pop up overlay window which enables the viewing to stay on the first level. This also enables the search engine crawlers to not only find information on the main pages, but all drawer information is search friendly as it is found on the first level too.

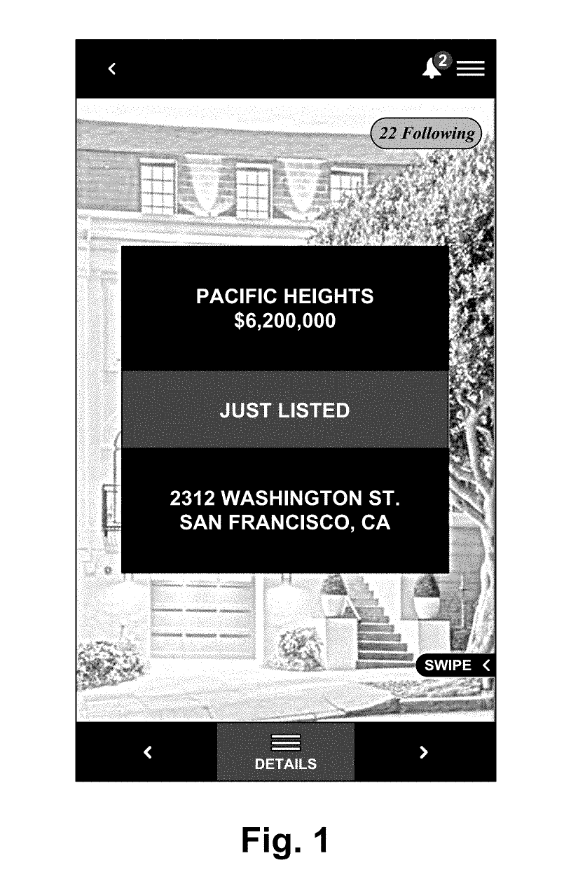

FIG. 1 shows a screenshot of a main page according to some embodiments. A “DETAILS” button at the bottom of the main page pulls up the drawers which remain on a first level page. As described herein, a drawer is a second level of information such as a second level window.

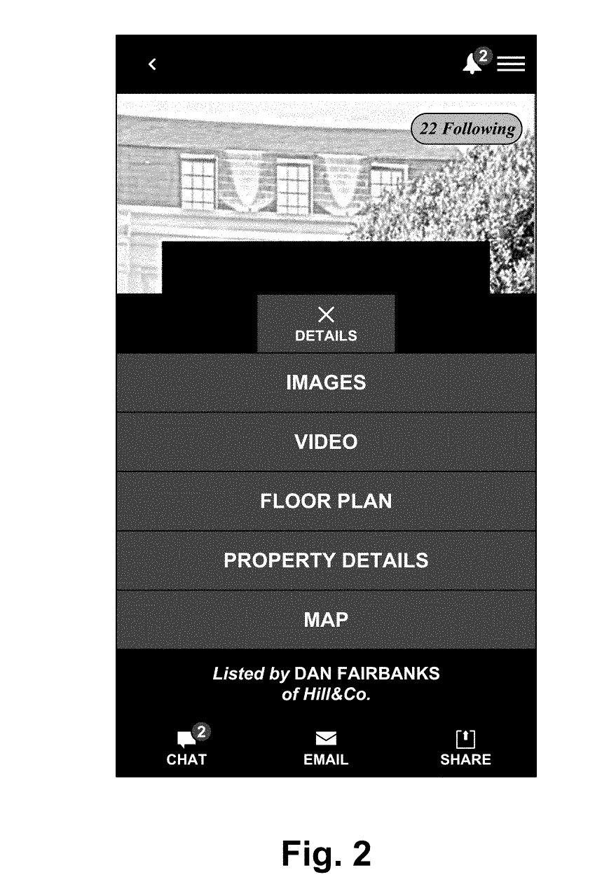

FIG. 2 shows a screenshot of the drawers according to some embodiments. The drawers include “images,” “video,” “floor plan,” “property details,” and “map” information. Any type of drawers are able to be included. For example, drawers for a vehicle page could include maintenance history or any other type of information.

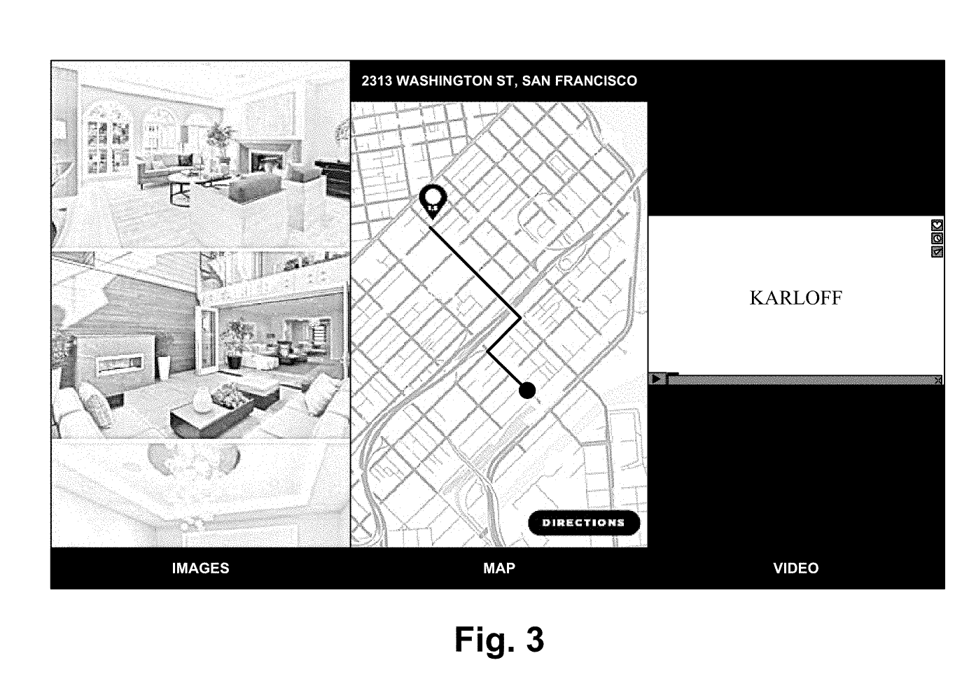

FIG. 3 shows screenshots of an image drawer, a map drawer and a video drawer according to some embodiments. As described herein, the drawers open on the first level in a pop up overlay.

In some embodiments, a community powered Search Engine Optimization (SEO) is implemented. Single property/product websites like all website take expertise and time to optimize. For example, real estate agents often make a single property website for a property listing for sale or rent. These single property websites take time to optimize. There are real estate syndicator platforms such as Trulia, Zillow, Realtors.com, Redfin and more. They aggregate many listings and achieve SEO benefits from all of their listings, and because they have a plethora of properties, their listings usually come up in the search results and take search engine priority even before the real estate agent's single property listing. There are many factors and even unknown algorithms that affect SEO. One main factor is having a syndication platform of multiple listings. This is the Achilles Heel of the single property website and of the real estate agent. Having a platform portal of multiple single property websites will allow real estate agents to leverage the power of the community so that when they have a brand new single property listing on a site/platform such as FlipClip, each listing on FlipClip will get a unique identifier URL such as: www.FlipClip.com/2312WathingtonStreet94551 (FlipClip+StreetAddress+City+ZipCode (in some embodiments, not all of these factors need to be in the unique URL; it could just be street address and zip code or something else).

Each new listing that an agent adds will add SEO benefits to the other listings on the platform, and this is referred to as a community-powered SEO. The real estate agent receives many benefits of the FlipClip platform such as the SEO benefits but also receives the benefits of a single product website such as users specifically contacting that real estate agent regarding a listing.

In some embodiments, easy zooming of a panoramic image on a mobile device is implemented. In some embodiments, the image is part of a page flipping book. A FlipClip platform includes multiple images (in any layout such as a portrait square or landscaped), and as a user moves (e.g., scrolls), there is a transition to another image. For example, if there are 9 images arranged in a 3×3 grid, and assuming the user begins looking at the zoomed in upper left corner image, as the user scrolls to the right, there would be a transition from the upper left corner image to the upper middle image and so on. In some embodiments, the transition is performed in a slide show fashion such as a horizontal or vertical swipe from image to image. In some embodiments, the transition is able to be done with a natural page flip as described in U.S. patent application Ser. No. 14/634,595, filed Feb. 27, 2015 and titled, “COMMUNITY-POWERED SHARED REVENUE PROGRAM,” which is hereby incorporated by reference in its entirety for all purposes. For example, when doing a natural page flip, the appearance of the page remains the content item (e.g., image) until the page is fully flipped. The opposite side of the page being flipped is the next content item. In some embodiments, the page flips at approximately the middle of the content item with a first portion of the content item remaining stationary and the second portion flipping. When the second portion is flipping, the next content item within the group is partially displayed, and more of the next content item is displayed as the page is flipped until it is fully flipped, and the next content item is fully displayed. For example, a user swipes her finger on the displayed content of a content group on a smart phone display to flip pages from right to left to display additional content within the group. As the user swipes her finger, the content item is divided in half, and the right half turns as a paper page would by following the user's finger. The page is fully viewable while it is being flipped. For example, the left half of an image and the right half of an image are viewable while a page is being flipped. Additionally, on the opposite side of the flipping page is the left portion of the next content item. The user is able to move the flipping page back and forth, and the content item is displayed on the left side including the front of the flipping page, and the next content item is displayed on the right side including the back of the flipping page. In some embodiments, the page flipping is able to be performed vertically. For example, instead of flipping right to left and left to right, the page flips top to bottom and bottom to top, again possibly from the (vertical) middle of the page. In other words, the horizontal flipping is turned 90 degrees, so now the same features/effects occur but vertically instead of horizontally. In some embodiments, the transition is done with any other animation such as a dissolve, theatre curtain split or other transitions.

In some embodiments, images on main pages are stacked so the user is able to view in a vertical scroll and/or pan left/right on each image stacked vertically.

In some embodiments, the gyroscope and accelerometer of a device are accessed to manipulate the image and/or page flipping book such as to activate the vertical scroll of a stacked image, or the scroll is able to be a vertical touch swipe. The user is able to tap on a main image to remove top and bottom bars to view even more of the image.

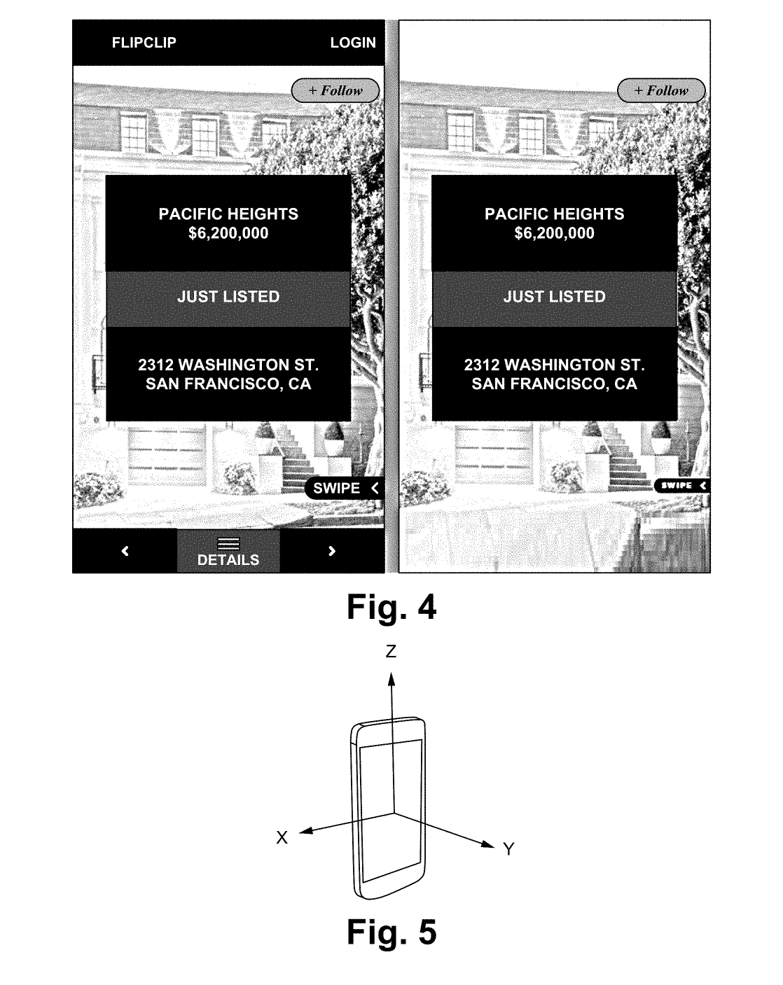

FIG. 4 shows screenshots of images with the top and bottom bars and without the top and bottom bars according to some embodiments. The screenshot on the left is with the top and bottom bars, and the screenshot on the right is without the top and bottom bars. The user is able to turn pages or go from slide to slide without the view of the top and bottom bars. When the user wants the tools back (e.g., on the bars) the user taps again, and the bars come back into view.

The FlipClip main pages are able to contain: images (e.g., GIF, PNG, JPG), video, text, 3D images, maps, sound, review widgets, buy buttons, shopping carts and payments gateway widgets, analytic buttons, promote posts or buy advertising buttons, excel spreadsheets, widgets, scheduling, email merge, email campaigns, CRM integrations, email, call, instant chat, Internet messaging, apps, platform, PDFs, slide shows, integrations, polling (e.g., vote widgets), stickers, code snippets, automated functions (e.g., if this, then that) that programmatically integrate tasks with other platforms, ad buy, promote a post widget, and more. The FlipClip drawers are able to contain: images (e.g., GIF, PNG, JPG), video, text, 3D images, maps, sound, review widgets, buy buttons, shopping carts and payments gateway widgets, analytic buttons, promote posts or buy advertising buttons, excel spreadsheets, widgets, scheduling, email merge, email campaigns, CRM integrations, email, call, instant chat, Internet messaging, apps, platform, PDFs, slide shows, integrations, polling (e.g., vote widgets), stickers, code snippets, automated functions (e.g., if this, then that) that programmatically integrate tasks with other platforms, ad buy, promote a post widget, and more.

A zoom implementation is a new user motion controlled way to view smart phone images. Many images are taken in landscape mode. A smart phone view port is portrait. With the zoom implementation, the image is brought in landscape but in fit to fill mode: meaning the image is expanded however it is as small as it is able to be to fully fill out the view port. The user is able to now pan left and right (in some cases up and down if the image is coded to bring in even larger than “fit to fill”) to view the expanded details of the image.

In some embodiments, the images are stitched together vertically and/or horizontally, and the images are placed in a viewer to generate a larger image that is able to be viewed.

An advantage of an expanded image is when generating a page flipping book, a user is able to generate hotspots which are: words that appear as user pans over a particular spot on the image or markers that appear when user pans over a particular spot on the image. The user is able to select the marker which will open a pop-up (on a first level with more web search crawler searchable information). A small image is too small to have multiple hotspots as the words or markers would overlap each other and “over take” the view of the main image.

When a person views an image on a smart phone, the user usually holds the phone in “prayer-book” position (e.g., with the back of the device roughly pointing towards the ground). When the user takes a photo, the user changes the way they hold the phone in an upright vertical position. Smart phones have an accelerometer which can provide a directional signal when a phone is moved.

FIG. 5 shows three axes for the accelerometer according to some embodiments. The X-axis provides a signal for left and right movement. The Y-axis provides a signal for in and out movement. The z-axis provides a signal for up and down movement. The gyroscope is built into the phone and used to detect the phone's orientation in space.

When the phone or other device (e.g., tablet) is held in a predetermined range-of-verticality position that is likely to be close to vertical (+ or −10%) the image expands to a large image, and the user is able to view all areas of the image by panning the phone in space, and the image view moves across the phone view in response to the user's hand movement. For example, if the user moves left (or moves the phone left), the image moves left (or right depending on the implementation). If the user pushes the phone away, the view gets larger, and pulling the phone in, the view gets smaller (or vice versa).

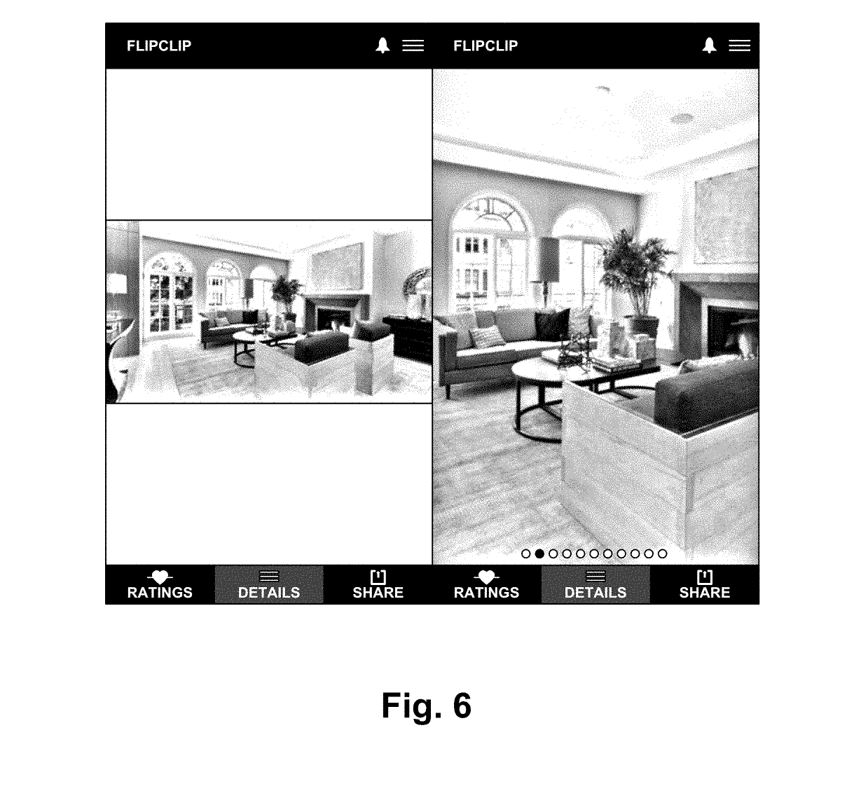

FIG. 6 shows screenshots of real estate images according to some embodiments. Most real estate images are landscaped (e.g., left screenshot). The view port on the phone is portrait when held vertically, so the image is “fit to fill,” and there is no background in view (e.g., right screenshot). For example, a page of the page flipping book is larger than the view port of the phone when held vertically, so the viewer is able to pan and see the image move through the view port. Similarly, when the phone is held horizontally, the view port is landscaped, but the image may be larger than the view port.

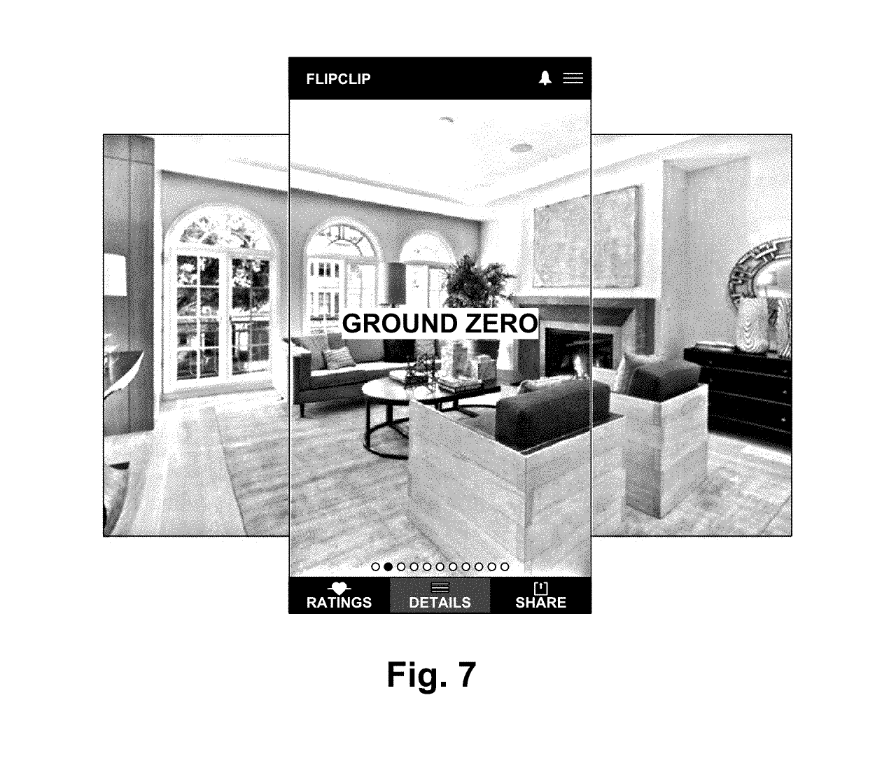

FIG. 7 shows a screenshot of a real estate image with much of the image cropped or out of sight according to some embodiments.

By accessing the accelerometer and gyroscope on the phone and executing program code, the user is able to move the phone to explore all areas of that image, meaning the image moves in response to the hand movement of the user.

The phone-screen's displayed image moves in response to the phone's sensors-signals that the person's hand is moving in the direction they want to see the image. For example, if the viewer wants to see part of the image on the LEFT, the user moves the phone to the LEFT side of the image, and if the user moves the phone to the RIGHT, as the phone physically moves the RIGHT, the image display moves (pans) to the RIGHT (or vice versa). Other movements of the device to affect the displayed image are possible as well.

Ground zero as shown in FIG. 7 is the position (where in the photo and zoom level) the image opens. In a typical scenario the image would programmatically open in the horizontal center. In another scenario the user could select the positioning of the image when the user set the image in a design studio.

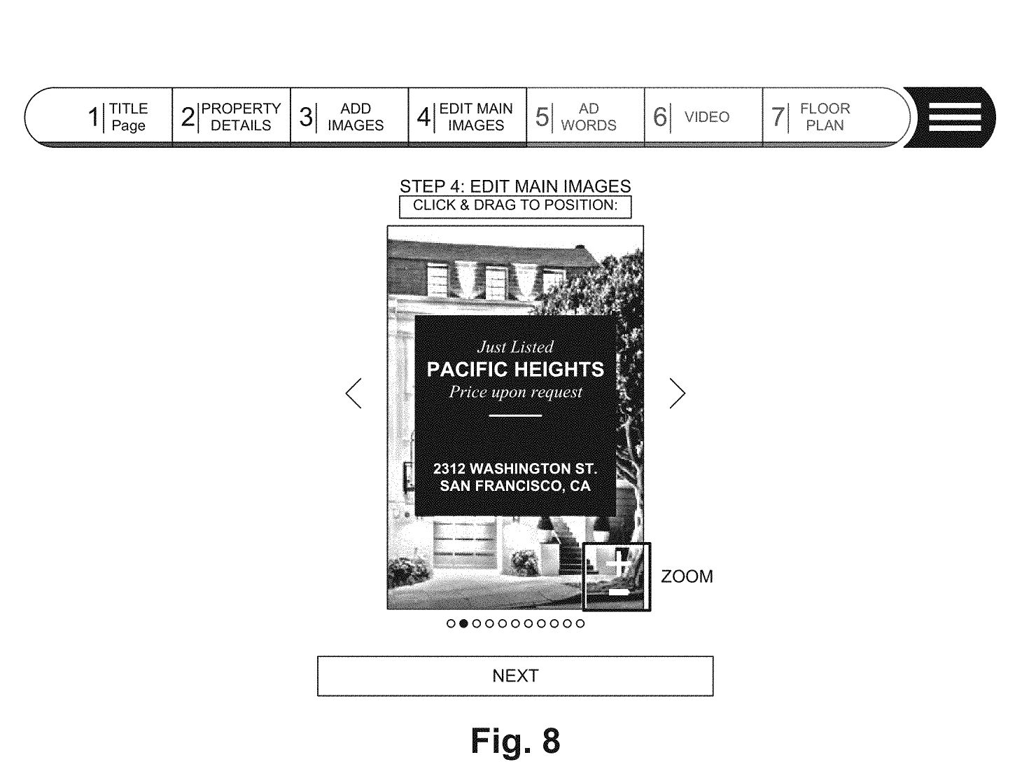

FIG. 8 shows a screenshot of a tool to edit an image according to some embodiments.

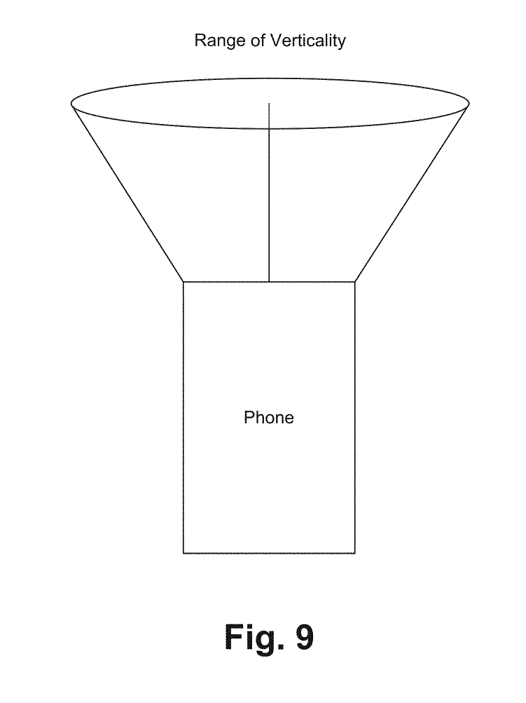

The vertical position of the phone is determined (is it lying flat or upright?), and then a range of acceptable “verticality” is established. For example, it is determined when the phone is upright as that is when a feature will engage, for example, the sensor is set to detect a range of verticality of + or −10%. FIG. 9 shows a diagram of an exemplary range of verticality according to some embodiments. When an app detects that the phone is in the acceptable range of “verticality” then the zoom implementation engages which expands the image to a preset zoomed level. When the phone reaches the limits of the image boundary the panning stops, and waits. When the user moves back, the panning continues. In some embodiments, a “freeze” function is able to be implemented where a user is able to “thumb-tap” on the phone screen. This freezes the phone view and allows for the user to bring the phone back closer to them. It will be natural for user to reposition and hold the phone still for a moment. When the phone sensors detect that motion has stopped the zoom implementation will unfreeze the view, and user can begin the panning view again. In the horizontal view, the user is able to tilt the phone to a horizontal view, and as long as the user holds the phone in the range of verticality the zoom implementation will engage and function the same way as the portrait view.

The zoom implementation is able to be utilized with a desktop computer. For example, a full website desktop view is able to be opened in the zoom implementation, and the user is able to pan up, down, left and right. This enables a user to view a large canvas on a desktop site.

In some embodiments, motion gestures are detected. In a horizontal view, a user typically pans with more of an up and down motion on a portrait image. In a portrait view, a user typically pans with more of a left to right motion with landscape and panoramic images. The user also likely zooms into the image by a large amount, and on both horizontal and portrait views, the user can pan left, right, up, down and push in to further zoom and pull away to expand the view (or vice versa). In some embodiments, when zooming in/out based on pushing or pulling the phone towards the user, the device utilizes a depth map to determine how much to zoom. For example, using a camera in a phone, the device is able to determine how far the user's face is from the camera, and that distance is the starting point for the zoom (e.g., after a user triggers the zoom implementation). Then, as the phone is moved either toward or away from the user's face, the distance from the face changes meaning the depth map changes, which is able to be used to determine the amount of zoom.

In some embodiments, the image is coded as a 3D image, and the user is able to tilt or pan the phone, or touch the screen to explore the image in 3D.

In some embodiments, the user is able to motion with a tilt “away” to shrink and tilt “toward” the user to expand the image, video or map (or vice versa). For example, a user tilts the phone from an approximately 90 degree vertical position so that the top of the phone tilts either forward or backward. Using the accelerometer and/or gyroscope, the phone detects the change in tilt, and based on the change in tilt, the zoom implementation zooms in or out on the image. In some embodiments, the amount of zoom on the image is linearly related to the amount of tilt. For example, for each degree the phone is tilted either forward or backward, the image is zoomed in or out 1 percent or 1 unit (e.g., 10× zoom per percent). In some embodiments, the amount of zoom is exponential such that the more the phone is tilted, the image is zoomed in or out at an exponential rate. For example, initially the tilt only zooms in or out a slight amount, but as the phone approaches horizontal, the zoom amount increases significantly (e.g., 1.5× zoom initially but 50× zoom when approximately horizontal). In some embodiments, the zoom amount is adjusted in distinct increments. For example, when the phone is tilted 10 degrees from vertical, 10× zoom (or −10× zoom meaning zoom out) is implemented, and when the phone is tilted 20 degrees from vertical then 20× zoom (or another zoom amount) is implemented, and so on, and the zoom only changes when a trigger point is reached (e.g., 10 degrees, 20 degrees, 30 degrees, and so on).

In some embodiments, the user is able to expand the image by a pinch and squeeze gesture.

Additional gestures are able to be utilized as well. For example, a finger tap on the back of a phone is detected by a sensor (e.g., a specific sensor configured to detect taps (vibrations) on the back of the phone), and when the tap is detected, a page of the page flipping book turns. In some embodiments, the sensor or a plurality of sensors bifurcates the phone so the side of the phone the finger tap occurs on is detected. For example, if the user taps the back left of the phone, then the page turns left, and if the back right of the phone is tapped, then the page turns right. Similarly, the phone could be bifurcated horizontally (to separate a top and bottom), so that back-top and back-bottom taps are sensed, to flip pages up and down. In some embodiments, when a user pushes a phone away from them, the image viewpoint gets smaller (or larger), and in some embodiments, when the user pulls the phone toward them, the image gets larger (or smaller). In some embodiments, when a user tilts the phone away from the user, the images scroll up (if they are vertically stacked), and when a user tilts the phone toward the user, the images scroll down (if they are vertically stacked). In some embodiments, a twist of the wrist turns the page, and an opposite twist of the wrist reverses the page turn (e.g., twist to the left versus twist to the right).

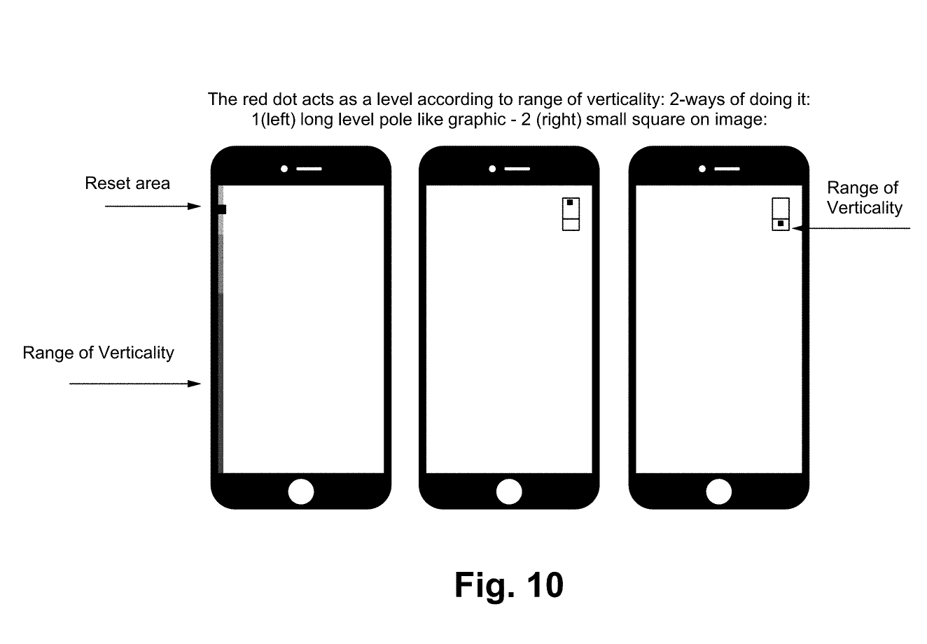

FIG. 10 shows a diagram of an indicator marker for the user to see if they are in a range of verticality according to some embodiments. The dot follows the vertical orientation of the phone.

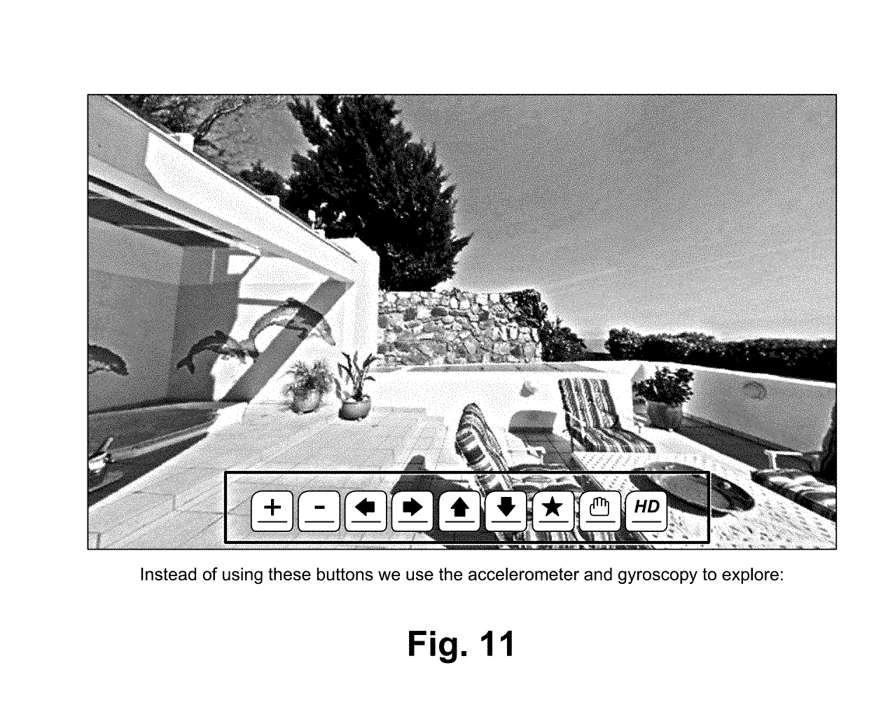

FIG. 11 shows a screenshot of a 3D view controllable with the accelerometer and/or gyroscope according to some embodiments. For example, instead of simply viewing 2D images, 3D images or video are accessible and controllable using the accelerometer and/or gyroscope. As described herein, instead of using button presses, the accelerometer and/or gyroscope detect movement and angling of the device and then navigate the 3D image based on the detected movements. For example, if a user tilts his phone to the left, the 3D image scrolls to the left. Similarly, the phone is able to be used to navigate virtual reality content. In some embodiments, the 3D image is a 360 degree panoramic image.

For example, for video, a horizontal video is viewed on a portrait page in “fill” mode such that the video filled out the page (e.g., vertically) but extended beyond the page/screen horizontally. Furthering the example, the only approximately one-third of the video is displayed on the screen; however, a user is able to pan left and right by moving the device. The video is able to be displayed in any manner such that a user is able to navigate the video as described herein regarding an image. For example, the user is able to pan left, right, up and/or down (or other directions such as diagonally), the user is able to zoom in or out on the video, and/or the user is able to perform any other navigational tasks.

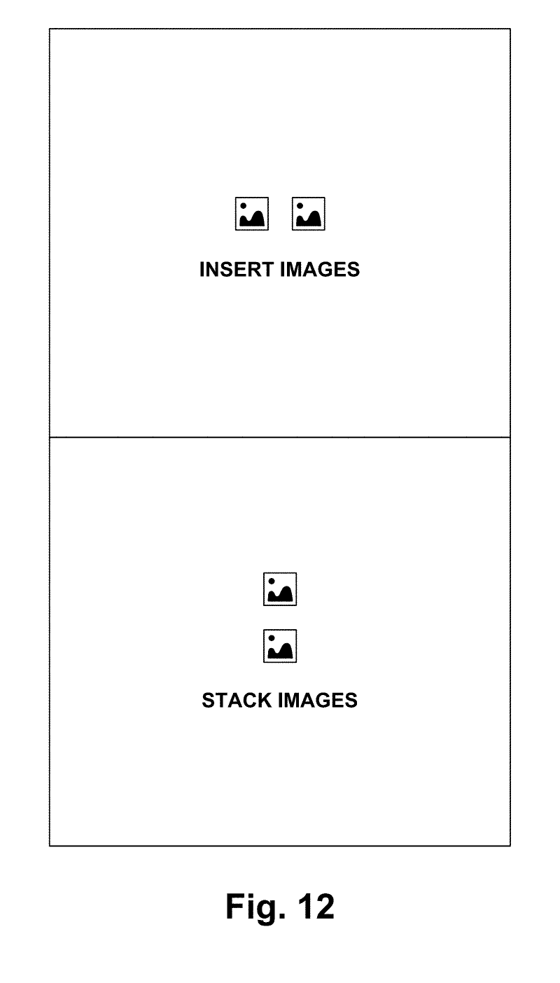

FIG. 12 illustrates a screenshot of configurable display options according to some embodiments. For example, the user is able to have the images displayed side by side or stacked upon each other. In some embodiments, the user is able to select how the images are displayed.

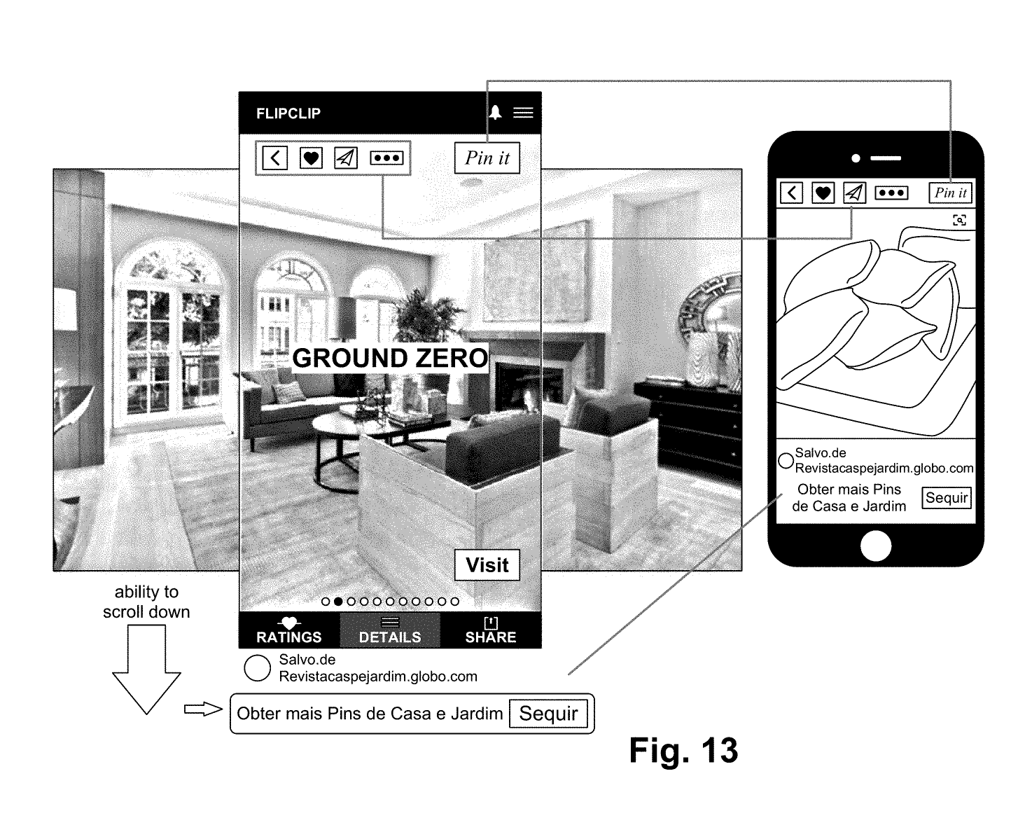

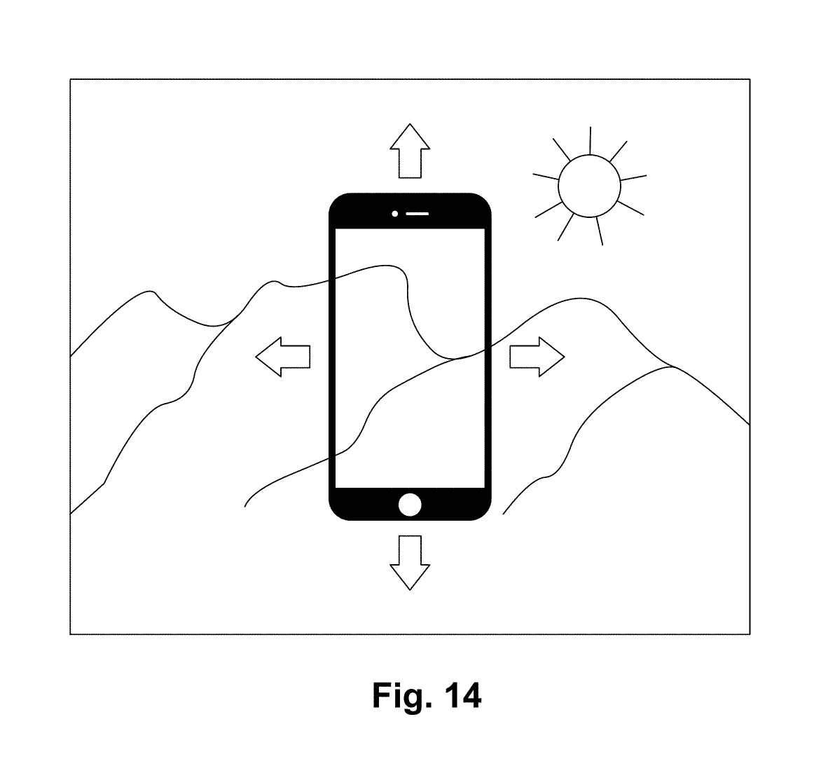

FIG. 13 illustrates a screenshot of the zoom implementation with platform tool buttons accessible according to some embodiments. As shown, although the zoom implementation is being utilized to view the image, in some embodiments, platform tools are still accessible such as at the top or bottom of the screen.

The zoom implementation is able to be utilized in cooperation with or performed on images (e.g., GIF, PNG, JPG), video, text, 3D images, maps, sound, review widgets, buy buttons, shopping carts and payments gateway widgets, analytic buttons, promote posts or buy advertising buttons, excel spreadsheets, widgets, scheduling, email merge, email campaigns, CRM integrations, email, call, instant chat, Internet messaging, apps, platform, PDFs, slide shows, integrations, polling (e.g., vote widgets), stickers, code snippets, automated functions (e.g., if this, then that) that programmatically integrate tasks with other platforms, ad buy, promote a post widget, and more. Any of these items (e.g., images, video, and so on) are able to be opened from a news feed on a social networking site (e.g., Pinterest, Twitter, Facebook). Email, ebooks and eink are also able to be viewed using the zoom implementation. For example, a user is able to read an email using jumbo size letters (e.g., zoomed in on the text). Furthering the example, by tilting the phone toward or away from the user, the text is zoomed in or zoomed out, and then by tilting the phone left, right, up or down, the view of the text is moved so the user is able to easily read the email or ebook.

In some embodiments, a user is able to tilt and/or freeze a device to scan through a news feed. For example, the user tilts a phone to scan through the news feed, and the more the phone is tilted, the more the scanning accelerates (e.g., an accelerated scroll) or the faster the scanning goes. In some embodiments, the tilting is based on tilting towards the user and away from the user. For example, tilting the phone away from the user scrolls to see older posts, bringing the phone back to vertical stops the scrolling, and tilting the phone toward the user scrolls to newer posts. In some embodiments, the tilting is left and right. Any of the tilting implementations described herein (e.g., the tilting related to zoom) are able to be applied to scanning through news feeds and/or other content (e.g., browsing slide shows or watching videos).

The zoom implementation is able to open a video that is zoomed in (or zoom in on a video) and then pan in any direction in the zoomed in video. Similarly, any content is able to be zoomed in or out, and then the user is able to pan in any direction in the zoomed in or out content.

The zoom implementation is able to be utilized with local or cloud-based camera/photo apps such as Camera Roll.

The zoom implementation is able to include a zoom Application Programming Interface (API), so that other platforms are able to easily integrate the zoom implementation.

The zoom implementation and other content manipulation are able to be controlled using voice commands and artificial intelligence (e.g., Siri, Cortana).

When taking pictures, a device (e.g., camera or camera phone) captures an image, and in addition, the camera is also able to capture a wide angle photo of the same shot. The view port opens the image of the composition the photographer had in mind, but the user is able to pan to see more. In some embodiments, a wide angle lens is utilized to acquired the photos.

A native program (e.g., coded in a device) allows a user to open an image or album using the zoom implementation. In some embodiments, the native program includes design and editing tools.

An API offers additional zoom implementations in a sandbox (e.g., page transition animations, custom branding (skinning with logos)).

The zoom implementation is able to be a native application, a mobile web implementation (e.g., html and/or Flash), a browser-accessible application (e.g., embedded in a browser), an installed application, a downloadable application, and/or any other type of application/implementation.

The zoom implementation is able to be utilize on any device such as a smart phone, a smart watch, or a tablet computer.

FIG. 14 illustrates an exemplary representation of panning through a large image on a mobile device according to some embodiments. As described herein, although the phone or other device is only able to display a small part of a large image, a user is able to pan, zoom and/or apply other viewing effects to the image based on motion (e.g., by moving the device). For example, by moving the device left, right, up or down, the user is able to pan left, right, up or down in the image to view other parts of the image.

As described herein, using the zoom implementation, any type of panning, zooming, scrolling or other movements of an image are able to be implementing. The zoom implementation is able to be implemented on any type of device such as a smart phone, tablet, or a smart watch. The zoom implementation is able to auto-fill the phone display with the image such that the phone display is fully or substantially, fully displaying part of the captured image, where the image is much larger than the display of the phone. As described, the phone utilizes the accelerometer and/or the gyroscope to enable navigation of the full image without the user swiping the screen; rather, the displayed portion of the image is based on the user moving the phone. For example, the user is able to move the phone left, right, up, down or a combination thereof, and the portion of the image displayed moves accordingly (or oppositely).

In some embodiments, there are multiple images or an album of images, and there is a transition to another image, as described above. The transition is able to be an animation such as a slideshow, page turn or another transition to another image, and in some embodiments, the transition is seamless such that the user does not know multiple images are stitched together. The transition to the other image is able to be triggered in any manner such as selecting (e.g., tapping) an icon on the screen to go to the other image or moving the phone in a manner in an appropriate manner to go to the other image. For example, a user is viewing a living room photo of a house by panning left and right with the phone, and to transition from the living room to the hall of the house, the user gestures/moves the phone in a flicking manner (e.g., quick tilt/flick of the top of the phone forward) when the hall is able to seen in the living room photo, or when the user is at the edge of the living room phone, or when a highlight/glow feature is illuminated indicating a transition is possible.

In some embodiments, an algorithm is implemented to determine the resolution and/or size of an image and how much the image is able to be zoomed in to still view the image at an acceptable resolution. For example, the algorithm analyzes image metadata to determine the resolution, and based on the determined resolution, a zoom factor is limited (e.g., to 100×). Generally, higher resolution images are able to be zoomed in further.

In some embodiments, an algorithm is implemented to control (e.g., throttle) the speed that an image is panned/moved. The speed control is able to be implemented based on the size/resolution of the image. Without the speed control, a wider/taller image may pan/scroll very quickly, and a narrow/short image may pan slowly, so the speed control is able to ensure that the images scroll at the same speed such as by factoring in the dimensions of the image, and using the dimensions to increase or decrease the speed of the pan/scroll such that the speed is the same for all images.

In some embodiment, tall images and/or wide images are cropped using the camera/phone hardware and/or software.

In some embodiments, tall and/or wide images are imported to a canvas or other program where user motion control is added to the image by cropping out the sides and opening the image in an auto-fill mode.

In some embodiments, the phone/camera takes a multiplicity of images, and each image is sent to a design studio (or other device) to apply user motion control to the image. In some embodiments, the phone software is configured to display images with user motion control features (e.g., panning by moving the phone).

In some embodiments, the camera takes a succession of images, where there is a sound and/or visual countdown for users to hear/see when the camera is going to take a picture. The camera is also able to be triggered to take a picture based on a sound such as a snap or clap. In some embodiments, the user taps the back of the phone, and the phone detects the motion or vibration to activate a feature such as taking a picture and/or turning a page or slideshow. This enables one-hand viewing/image taking.

In some embodiments, the user is able to toggle the user motion control on/off.

In some embodiments, the user is able to insert stacking images up/down or left/right images to a page (e.g., web page or album), and the page is coded with user motion control panning. For example, instead of executing the zoom implementation as an app, the zoom implementation is embedded/executed in a web page (e.g., as a script).

In some embodiments, a user is able to clip images from the web, and user motion control is implemented depending on the size and orientation of the image. Clipping images from the web is able to be implemented in any manner such as a screen capture implementation (or a crop implementation similar to a photo editor crop tool) which is able to capture a web page or part of a web page (e.g., an image). In some embodiments, a user clips a websnap image (e.g., an image of a web page), and user motion control is applied in a design studio or a viewing implementation.

In some embodiments, there is a viewing implementation of a web page, and the user motion control is applied for viewing (e.g., up/down, left/right, all around). The user is able to select (e.g., a gestured such as tap) on the viewing implementation to freeze movement. The user is then able to move the phone without the displayed image changing. A subsequent selection (e.g., a second tap) allows motion; however the new view starts at the point that the user left off in the image again. The viewing implementation begins the calculations using the coordinates where the user left off. For example, if the user is viewing a web page which is very long, the user is able to scroll down the web page by moving the phone down, and then freezing the web page when the phone is down near the person's waist, then reposition the phone in front of the user, and resume scrolling down the web page where they left off when they froze the web page. Similarly, pdfs, Word documents, Excel spreadsheets, and other types of documents are also able to be viewed in this manner.

In some embodiments, the image is very large (e.g., a giga-pixel image) or not, and items are able to be placed in the image to turn the image into a game. For example, images of objects to find are placed in an image, and a scavenger hunt-type of game is implemented, whereby the user searches the image by moving the phone in any direction.

In some embodiments, augmented reality is utilized to give more information about a particular spot on the image that the user is viewing. For example, if the user is viewing an image with many buildings, augmented reality information such as addresses and/or building/business names are able to be displayed when each building is within a designated location on the phone (e.g., in the center or close to the center).

In some embodiments, a horizontal and/or vertical scroll bar that indicates to the user how much scrolling space they have.

In some embodiments, images are acquired using a drone, and the images are displayed using the zoom implementation such that a user is able to pan/scroll in the images. In some embodiments, the camera on the drone (or other device) crops the image with black bars on the top/bottom or sides and/or makes an album with a plurality of images with or without user motion control. In some embodiments, the drone includes any camera device, but the zoom implementation enables motion control of the drone-acquired images.

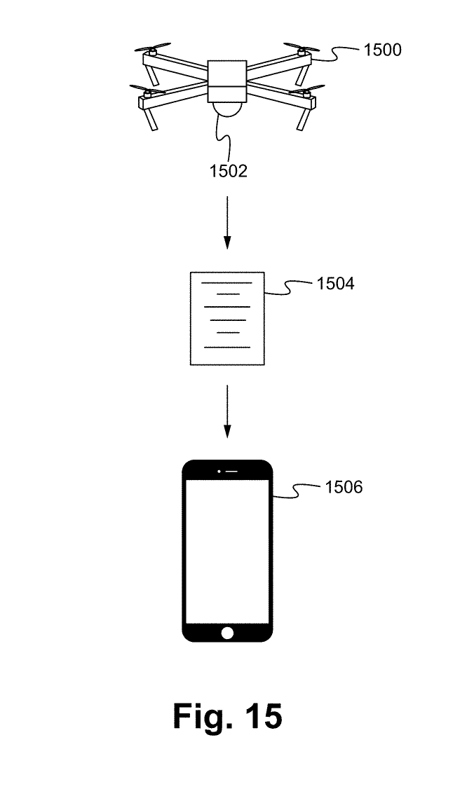

FIG. 15 illustrates a diagram of a drone being used in conjunction with the zoom implementation according to some embodiments. The drone 1500 is able to be any drone device (e.g., quadcopter) with a camera device 1502 configured to capture images. The drone 1500 sends the captured images to another device 1504 (e.g., a server). The device 1504 is then able to implement the zoom implementation or enable access from a user device 1506 which implements the zoom implementation. In some embodiments, fewer or additional devices are implemented.

In some embodiments, the zoom implementation (or user motion control) is pre-installed on a phone or other device.

In some embodiments, motion control information is embedded within image metadata.

In some embodiments, the zoom implementation utilizes any type of image. In some embodiments, the zoom implementation utilizes only regular, non-panoramic images. However, the regular image appears to be a panoramic image by using the zoom implementation. In some embodiments, any type of camera is able to be used to acquire an image for the zoom implementation. In some embodiments, only specific types of cameras are utilized for the zoom implementation (e.g., point and shoot cameras). In some embodiments, the amount of degrees of an image is determined, and if the amount of degrees is below a threshold (e.g., below 100 degrees or below 160 degrees), then it is a standard image, and if it is above the threshold then it is a panoramic image, and the zoom implementation is utilized only for standard images, in some embodiments.

In some embodiments, an aspect ratio of a device view/display changes and engages a higher resolution for an image.

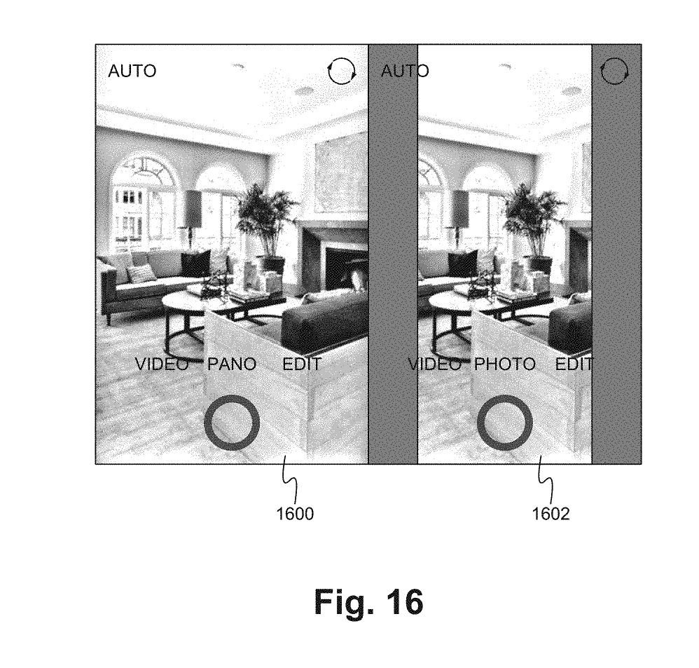

FIG. 16 shows an example of a photo mode view of an image and a pano (panoramic) mode view in a portrait display according to some embodiments. In the photo mode view 1600, the image is displayed to fill the entire display. In the pano mode view 1602, the image is displayed with black (or other color) bars/edges in the display.

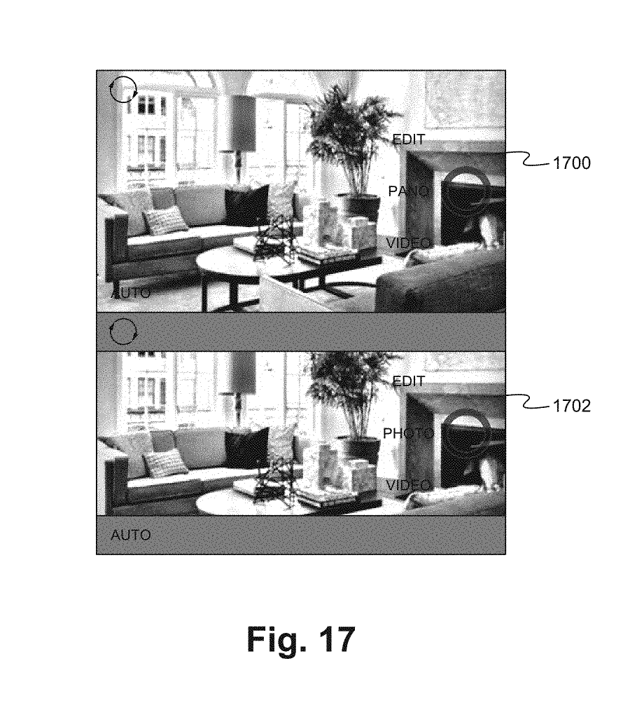

FIG. 17 shows an example of a photo mode view of an image and a pano (panoramic) mode view in a landscape display according to some embodiments. In the photo mode view 1700, the image is displayed to fill the entire display. In the pano mode view 1702, the image is displayed with black (or other color) bars/edges in the display.

The user is able to adjust the size/depth of the bars, and as a user makes the bars larger, the resolution of the image increases, and as the user makes the bars smaller, the resolution decreases. For example, a user clicks on one of the bars and drags the bar to the desired size, which affects the resolution of the image.

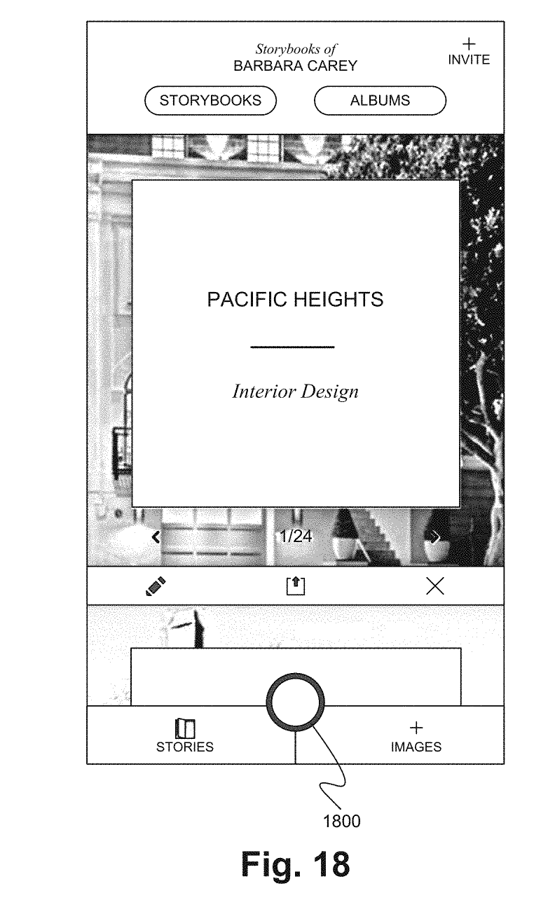

FIG. 18 shows an example of a button implementation according to some embodiments. In some embodiments, a photo and/or video button 1800 is implemented as a transparent or semi-transparent shape (e.g., circle) displayed on a screen of a device. A user presses the button 1800 to take a photograph and/or a video. In some embodiments, by pressing the button 1800 for a short period of time (e.g., less than a threshold such as half of a second) a picture is taken, and if the button 1800 is held in (e.g., longer than the threshold), then a video is taken until the button 1800 is released, the user presses the screen/button again or a time limit is reached. In some embodiments, a single tap triggers taking a photograph and a double tap triggers taking a video. Any other differentiation between taking a picture and video is possible such as a swipe left versus swipe right or a tap versus a swipe. In some embodiments, the touch is combined with another gesture/input such as a user saying “picture” and then tapping for pictures and the user saying “video” and then tapping for videos, or tapping and then saying a command. The video recording is able to be stopped using a single tap, double tap, based on a time limit (e.g., after 15 seconds the video recording stops) and/or any other implementation for stopping the recording.

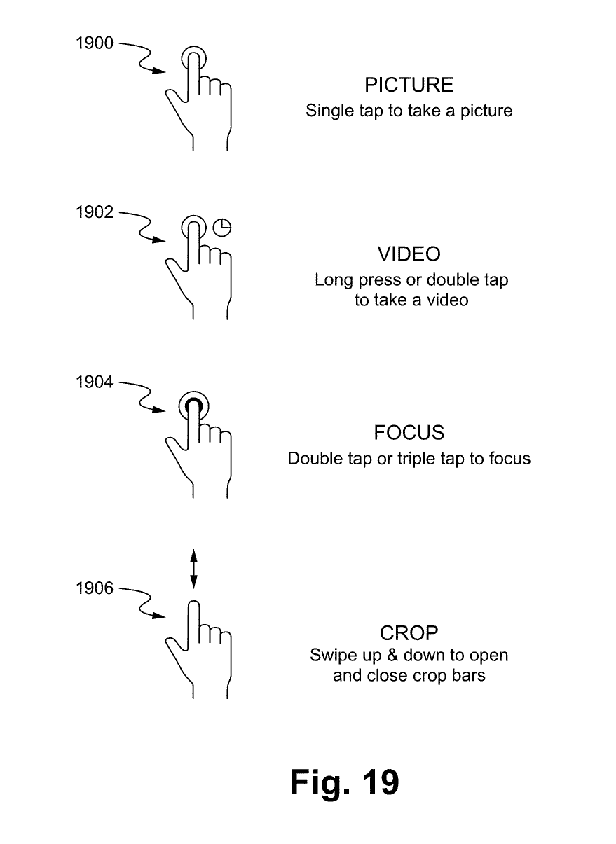

FIG. 19 shows an example of an implementation for acquiring pictures and videos according to some embodiments. In some embodiments, instead of having a designated button on the screen, then entire screen of the device is able to be pressed/tapped by a user to take a picture and/or video. A single tap 1900 takes a picture. For example, a single tap involves pressing the screen for a short period of time (e.g., less than a threshold such as half of a second). A long press or double tap 1902 takes a video. For example, a long press is touching the screen longer than the threshold. A double tap/triple tap 1904 adjusts the focus (e.g., causes the device to focus on the tapped item). The double tap is used when a long press is used for video or the triple tap is used when a double tap is used for video. A swipe 1906 enables the user to edit the acquired picture or video such as by opening and closing crop bars, or deleting the picture/video. In some embodiments, the implementations vary such as swipes performing different tasks, or another distinction between taking pictures and videos. Any other differentiation between taking a picture and video is possible such as a swipe left versus swipe right or a tap versus a swipe. In some embodiments, the touch is combined with another gesture/input such as a user saying “picture” and then tapping for pictures and the user saying “video” and then tapping for videos, or tapping and then saying a command. The video recording is able to be stopped using a single tap, double tap, based on a time limit (e.g., after 15 seconds the video recording stops) and/or any other implementation for stopping the recording.

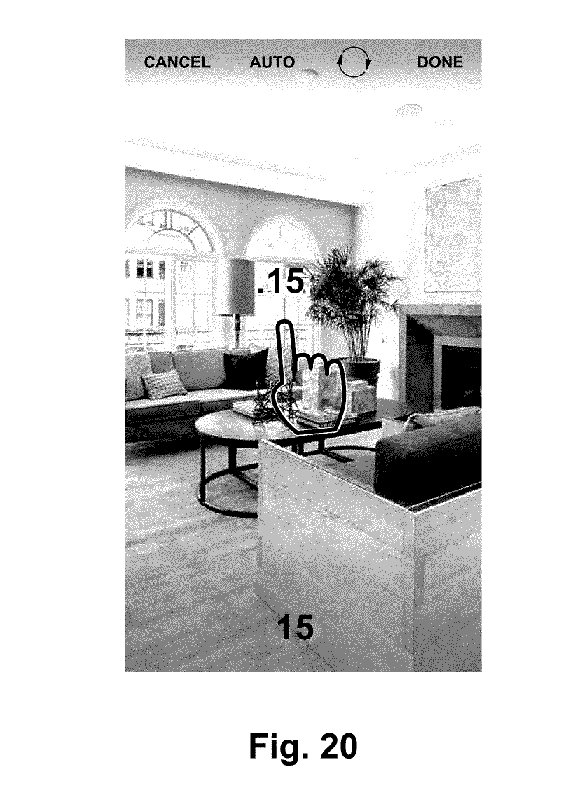

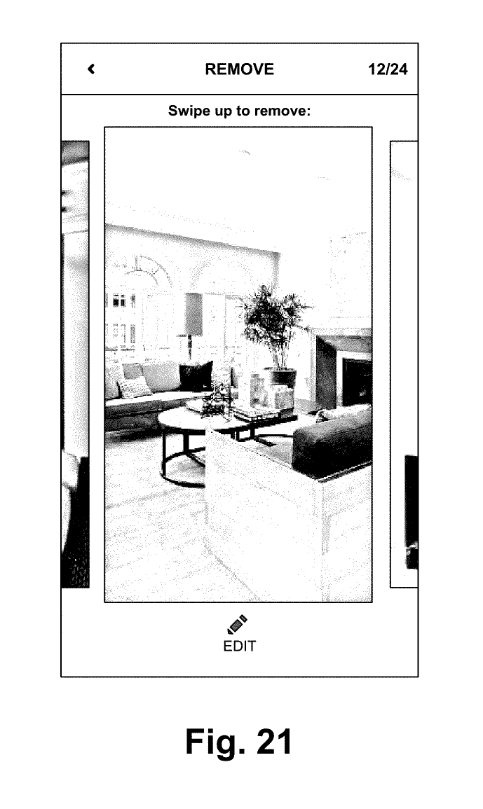

FIG. 20 shows an example of an implementation for acquiring pictures and videos according to some embodiments. For example, a user taps the screen to take a picture. After the user taps the screen, the scene viewed by the camera device is captured and stored on the device or in the cloud. Various features/settings are able to be applied/configured such as setting the flash to on/off/auto.

FIG. 21 shows an example of an implementation of editing acquired pictures or videos according to some embodiments. For example, a user is able to swipe up or down to remove/delete a picture or select an edit button to edit the picture. The videos are able to be played or edited such as segmented or merged.

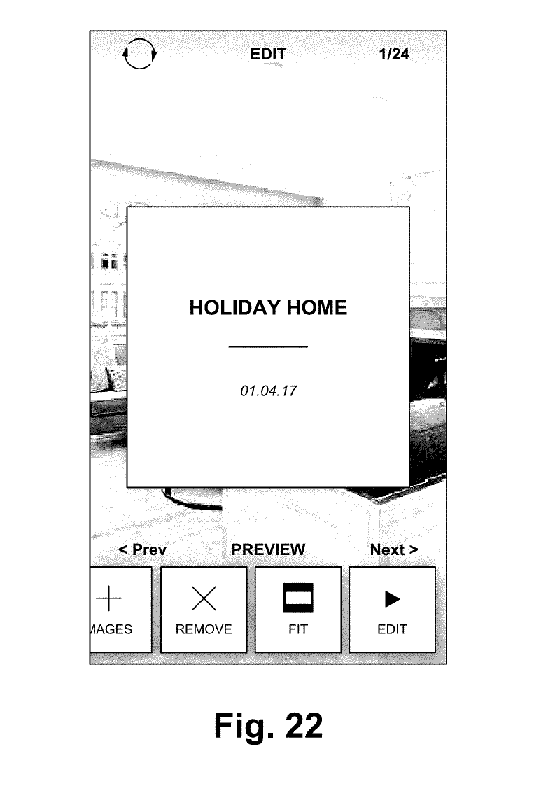

FIG. 22 shows an example of an implementation for utilizing the acquired pictures or videos according to some embodiments. After taking pictures/videos, the pictures/videos are able to be added to a page flipping book, the size/fit of the picture/video is able to be adjusted, and/or any other actions are able to be taken with/on the picture/video.

The button or whole screen picture/video capture implementations described herein are able to be used in conjunction with the zoom implementation in any manner. For example, a user acquires an image using the whole screen touch picture capture, which is then displayed using the zoom implementation which allows a user to view the image in a zoomed in manner while moving the mobile device to pan through the image.

In some embodiments, when a user selects (e.g., taps) an image, the image is displayed in the zoom implementation (e.g., loaded into the zoom implementation application), such that the user is able to pan and move the image around.

In some embodiments, the zoom implementation shows a main image which is able to be navigated (e.g., panned) while also displaying thumbnails or other information. For example, 80% of a screen displays an image with the zoom implementation while 20% (e.g., bottom, top or side(s)) of the screen displays thumbnails of other/related images, which are selectable and also viewable using the zoom implementation. In some embodiments, the thumbnails are overlaid upon the main image. Similarly, in some embodiments, smaller images are displayed as tiles or other shapes, and when a tile is selected, it becomes a focus of the display (e.g., it takes up a majority of the screen) and is displayed/navigated using the zoom implementation. In some embodiments, the zoom implementation is utilized with a page with a main image and thumbnails.

In some embodiments, the zoom implementation accesses an Internet Data Exchange (IDX) (or any other exchange, portal or database) to retrieve and display real estate images. The zoom implementation is able to couple with the IDX in any manner such as using an Application Programming Interface (API) which searches through and locates specific real estate listings and/or images related to the listings. In some embodiments, the zoom implementation is accessible when visiting a real estate listing.

In some embodiments, the zoom implementation is accessible/usable for any image (e.g., stored locally, web-based, stored remotely, any type of image) accessed/selected by a user. For example, the zoom implementation is able to run in the background or as a concurrent thread/application, and when a user selects an image, the image is displayed/navigated in the zoom implementation. In another example, as a user selects an image in a gallery, the zoom implementation is applied to the image or the image is accessed using the zoom implementation.

In some embodiments, the zoom implementation is implemented using a web-based implementation such as javascript. The web-based implementation is able to be a server-side implementation or a client-side implementation. For example, when a user visits a web site, the server for the web site (or the host) loads the web-based zoom implementation to enable the user to view and navigate images as described herein.

In some embodiments, a user's mobile device (e.g., smart phone) links to a second screen (e.g., television), and the content on the mobile device is displayed on the second screen. Further, the mobile device is able to be used to navigate the content on the second screen. For example, after linking the mobile device to the second screen (e.g., via Chromecast or Apple Air Play), when the user pans with her phone, the image on the second screen pans as described herein. Furthering the example, the user views images of a house for sale with the zoom implementation which is on the user's phone which is linked to the user's television, and as the user moves the phone to the left and right, the image moves to the left and right. The zoom implementation is able to be stored and implemented on the phone, the television and/or both. For example, the user's phone sends movement signals to the zoom implementation on the television which moves the image on the television. In another example, the television simply receives the movement information from the phone and adjusts the display purely based on the movement information without a zoom implementation application on the television. In another example, the zoom implementation application on the phone is capable of controlling more than one screen based on the movement and/or other input of the phone.

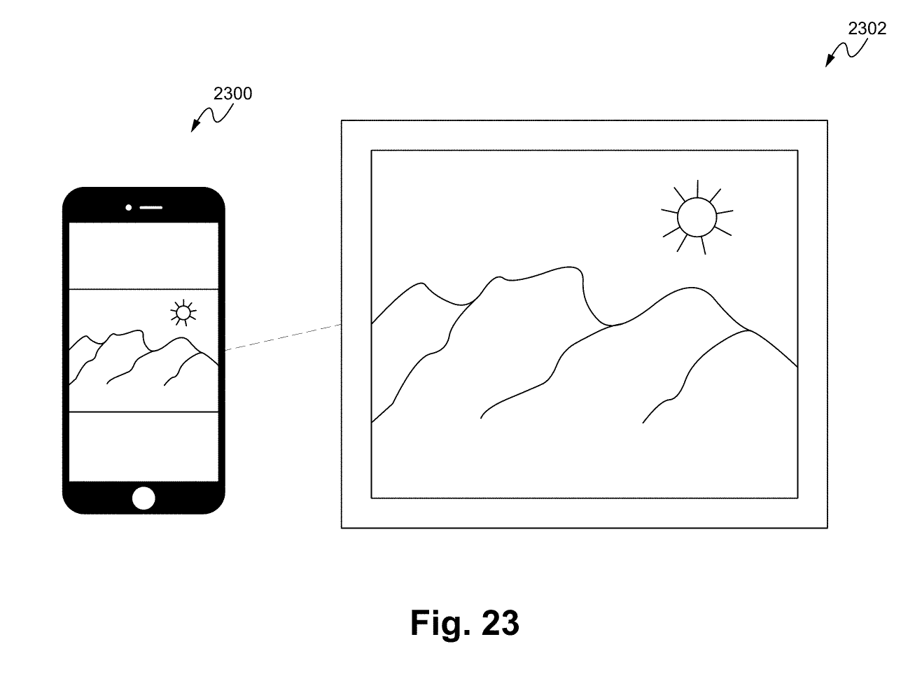

FIG. 23 shows a diagram of a mobile device controlling a display of a second device using the zoom implementation according to some embodiments. The mobile device 2300 is able to link to the second device 2302 (e.g., television) in any manner (e.g., wirelessly through Chromecast or Apple Air Play). The link allows the content on the mobile device 2300 to be displayed on the second device 2302. For example, images on or accessible by the mobile device 2300 are displayed on the second device 2302. Additionally, using the zoom implementation, the mobile device 2300 is able to navigate (e.g., pan, scroll, zoom) on the image and the navigation is shown on the second device 2302. For example, as the user moves the mobile device 2300 to the left, the image on the second device 2302 pans to the left (or right). The control/navigation information by the mobile device 2300 is able to be communicated to the second device 2302 in any manner as described herein. In operation, the zoom implementation enables users to immerse themselves in content by viewing as much of the content as their device screen permits and by enabling a user to navigate the content by moving the device. The device is able to provide content navigation using device hardware such as accelerometers and/or gyroscopes to pan, zoom and/or otherwise interact with the content. The zoom implementation is able to be utilized with standard images, video and/or any other content. Further, the content is able to be acquired using camera component of the device or using software of the device such as to clip web page content. By utilizing standard images and device hardware for navigation, the user experience is greatly improved.

Any of the implementations described herein are able to be implemented using object oriented programming (such as Java or C++) involving the generation and utilization of classes. For example, the zoom implementation is able to include a zoom class, a pan class and/or any other classes to control navigation and/or other aspects of the zoom implementation. Any other aspects described herein are able to be implemented using object oriented programming as well.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

We claim:

1. A method programmed in a non-transitory memory of a device, the method comprising:
displaying a zoomed-in version of content on the device; and
navigating display of the content using an accelerometer and/or a gyroscope of the device.

2. The method of claim 1 wherein the content comprises a plurality of images stitched together horizontally and/or vertically.

3. The method of claim 1 wherein the zoomed-in version of the content is a landscape image but in fit to fill mode while the device is held substantially vertically.

4. The method of claim 3 wherein substantially vertically is vertically, plus or minus 10 degrees.

5. The method of claim 1 wherein navigating display of the content includes moving the device in a left, right, up or down motion.

6. The method of claim 1 wherein the zoomed-in version of the content initially appears at the center of the content.

7. The method of claim 1 wherein a user selects where the zoomed-in version of the content initially appears.

8. The method of claim 1 wherein the content comprises a 360 degree 3D image or a video.

9. The method of claim 1 further comprising detecting a vibration on a back of the device using a sensor, and turning a page of a page flipping book upon detection of the vibration, wherein the content is part of the page flipping book.

10. The method of claim 9 wherein the sensor distinguishes a location of the vibration, and turns the page of the page flipping book based on the location of the vibration.

11. The method of claim 1 wherein the content becomes smaller based on the device moving away from a user.

12. The method of claim 1 wherein the content becomes larger based on the device moving toward a user.

13. The method of claim 1 wherein the content scrolls down such that a next content item appears when the device is tilted away from a user.

14. The method of claim 1 wherein the content scrolls up such that a next content item appears when the device is tilted toward a user.

15. The method of claim 1 wherein a page of a page flipping book turns based on detecting a wrist twist while holding the device, wherein the content is part of the page flipping book.

16. The method of claim 1 further comprising displaying tool buttons with the content, wherein the tool buttons are related to design and editing tools.

17. The method of claim 1 further comprising capturing the content, wherein the content is a wide angle version of the content, and a second non-wide angle version of the content is also captured.

18. The method of claim 1 further comprising transitioning from the content to a second content item.

19. The method of claim 1 further comprising analyzing metadata of the content to determine a resolution of the content, wherein the resolution of the content affects a zoom factor of the content.

20. The method of claim 1 wherein navigating display of the content includes a speed control based on a size of the content.

21. The method of claim 1 further comprising acquiring the content, wherein acquiring the content includes an audio or visual indicator to indicate when the content is acquired.

22. The method of claim 1 wherein a number of degrees of the content is less than a threshold.

23. The method of claim 1 wherein the content is acquired using a drone device.

24. The method of claim 1 further comprising adjusting a resolution of the content by adjusting a size of bars along an edge of the content.

25. The method of claim 1 further comprising acquiring the content by detecting a screen touch, wherein the screen touch for a duration less than or equal to a threshold acquires a picture, and the screen touch for the duration greater than the threshold acquires a video.

26. The method of claim 1 further comprising acquiring the content by detecting a screen touch, wherein a single screen touch acquires a picture and a double screen touch acquires a video, and acquiring the video stops based on a touch and/or a time limit.

27. The method of claim 1 wherein the content is accessed using an Internet Data Exchange.

28. The method of claim 1 wherein the zoomed-in version of the content is displayed in a web page.

29. The method of claim 1 wherein the zoomed-in version of the content is displayed on a second device.

30. A device comprising:
a non-transitory memory configured for storing an application, the application configured for:
displaying a zoomed-in version of content on the device; and
navigating display of the content using an accelerometer and/or a gyroscope of the device; and
a processor configured for processing the application.

31. The device of claim 30 wherein the content comprises a plurality of images stitched together horizontally and/or vertically.

32. The device of claim 30 wherein the zoomed-in version of the content is a landscape image but in fit to fill mode while the device is held substantially vertically.

33. The device of claim 32 wherein substantially vertically is vertically, plus or minus 10 degrees.

34. The device of claim 30 wherein navigating display of the content includes moving the device in a left, right, up or down motion.

35. The device of claim 30 wherein the zoomed-in version of the content initially appears at the center of the content.

36. The device of claim 30 wherein a user selects where the zoomed-in version of the content initially appears.

37. The device of claim 30 wherein the content comprises a 360 degree 3D image or a video.

38. The device of claim 30 further comprising detecting a vibration on a back of the device using a sensor, and turning a page of a page flipping book upon detection of the vibration, wherein the content is part of the page flipping book.

39. The device of claim 38 wherein the sensor distinguishes a location of the vibration, and turns the page of the page flipping book based on the location of the vibration.

40. The device of claim 30 wherein the content becomes smaller based on the device moving away from a user.

41. The device of claim 30 wherein the content becomes larger based on the device moving toward a user.

42. The device of claim 30 wherein the content scrolls down such that a next content item appears when the device is tilted away from a user.

43. The device of claim 30 wherein the content scrolls up such that a next content item appears when the device is tilted toward a user.

44. The device of claim 30 wherein a page of a page flipping book turns based on detecting a wrist twist while holding the device, wherein the content is part of the page flipping book.

45. The device of claim 30 wherein the application is further for displaying tool buttons with the content, wherein the tool buttons are related to design and editing tools.

46. The device of claim 30 wherein the application is further for capturing the content, wherein the content is a wide angle version of the content, and a second non-wide angle version of the content is also captured.

47. The device of claim 30 wherein the application is further for transitioning from the content to a second content item.

48. The device of claim 30 wherein the application is further for analyzing metadata of the content to determine a resolution of the content, wherein the resolution of the content affects a zoom factor of the content.

49. The device of claim 30 wherein navigating display of the content includes a speed control based on a size of the content.

50. The device of claim 30 wherein the application is further for acquiring the content, wherein acquiring the content includes an audio or visual indicator to indicate when the content is acquired.

51. The device of claim 30 wherein a number of degrees of the content is less than a threshold.

52. The device of claim 30 wherein the content is acquired using a drone device.

53. The device of claim 30 wherein the application is further for adjusting a resolution of the content by adjusting a size of bars along an edge of the content.

54. The device of claim 30 wherein the application is further for acquiring the content by detecting a screen touch, wherein the screen touch for a duration less than or equal to a threshold acquires a picture, and the screen touch for the duration greater than the threshold acquires a video.

55. The device of claim 30 wherein the application is further for acquiring the content by detecting a screen touch, wherein a single screen touch acquires a picture and a double screen touch acquires a video, and acquiring the video stops based on a touch and/or a time limit.

56. The device of claim 30 wherein the content is accessed using an Internet Data Exchange.

57. The device of claim 30 wherein the zoomed-in version of the content is displayed in a web page.

58. The device of claim 30 wherein the zoomed-in version of the content is displayed on a second device.

59. A network of devices comprising:
a user device configured for:
displaying a zoomed-in version of content; and
navigating display of the content using an accelerometer and/or a gyroscope of the device; and
a server device configured for:
processing the content.

60. The network of devices of claim 59 wherein the user device is further configured for transitioning from the content to a second content.

61. The network of devices of claim 59 wherein the server device is further configured for analyzing metadata of the content to determine a resolution of the content, wherein the resolution of the content affects a zoom factor of the content.

62. The network of devices of claim 59 wherein navigating display of the content includes a speed control based on a size of the content.

63. The network of devices of claim 59 wherein the user device is further configured for acquiring the content, wherein acquiring the content includes an audio or visual indicator to indicate when the content is acquired.

64. The network of devices of claim 59 wherein a number of degrees of the content is less than a threshold.

65. The network of devices of claim 59 further comprising a drone device configured for acquiring the content and transmitting the content to the server device.

66. The network of devices of claim 59 wherein the user device is further for adjusting a resolution of the content by adjusting a size of bars along an edge of the content.

67. The network of devices of claim 59 wherein the user device is configured for acquiring the content.

68. The network of devices of claim 59 wherein the server device is configured for acquiring the content.

69. The network of devices of claim 59 wherein the user device is configured for acquiring the content by detecting a screen touch, wherein the screen touch for a duration less than or equal to a threshold acquires a picture, and the screen touch for the duration greater than the threshold acquires a video.

70. The network of devices of claim 59 wherein the user device is configured for acquiring the content by detecting a screen touch, wherein a single screen touch acquires a picture and a double screen touch acquires a video, and acquiring the video stops based on a touch and/or a time limit.

71. The network of devices of claim 59 wherein the content is accessed using an Internet Data Exchange.

72. The network of devices of claim 59 wherein the zoomed-in version of the content is displayed in a web page.

73. The network of devices of claim 59 wherein the zoomed-in version of the content is displayed on a second device.
